(19) United States
(12) Patent Application Publication
(10) Pub. No.: US 2024/0202234 A1
(43) Pub. Date: Jun. 20, 2024

(54) KEYWORD VARIATION FOR QUERYING FOREIGN LANGUAGE AUDIO RECORDINGS

(71) Applicant: SRI International, Menlo Park, CA (US)

(72) Inventors: Andreas Kathol, El Cerrito, CA (US); Colleen Richey, Foster City, CA (US); Victor Abrash, Montara, CA (US); Homin Kwon, San Diego, CA (US)

(21) Appl. No.: 18/555,077

(22) PCT Filed: Jun. 23, 2022
(86) PCT No.: PCT/US2022/073113

§ 371 Date: Oct. 12, 2023

Related U.S. Application Data
(60) Provisional application No. 63/214,138, filed on Jun. 23, 2021.

(51) Int. Cl. G06F 16/632; G06F 16/683; G10L 15/00; G10L 15/08

(52) U.S. Cl. CPC G06F 16/632; G06F 16/683; G10L 15/005; G10L 15/08

(57) ABSTRACT

Techniques are disclosed for searching audio recordings in a second language with a key phrase in a first language. For example, a system as described herein receives a first key phrase in the first language and an audio recording in the second language. The system converts the first key phrase into a second key phrase in the second language. The system processes the second key phrase to produce a second key phrase variant. The system identifies, from a graph of words in the second language generated from the audio recording, instances of the second key phrase or the second key phrase variant within the audio recording. The system displays the identified instances of the second key phrase or the second key phrase variant within the audio recording to enhance searchability of the audio recording in the second language.

This application claims the benefit of U.S. Provisional Patent Application No. 63/214,138, filed 23 Jun. 2021, the entire contents of which is incorporated herein by reference.

### GOVERNMENT RIGHTS

This invention was made with Government support under contract number W911QY19C0064 awarded by the United States Special Operations Command. The Government has certain rights to this invention.

### TECHNICAL FIELD

This disclosure generally relates to speech recognition.

### BACKGROUND

Searching recorded audio for instances of a keyword is a time-consuming activity for humans. For instance, it may take hours for a person to listen to recorded audio to find a part of the recorded audio that the person was looking for. To date, machine learning algorithms to perform this activity have met with significant challenges. This problem may be compounded in the situation wherein the searcher speaks a first language, but desires to search an audio recording of a second language.

### SUMMARY

In general, the disclosure describes techniques for searching for the presence of a key phrase in a first language within an audio recording of a second, different language. Conventional applications for searching audio recordings in a foreign language may rely on translating each word of a search term in a native language into a corresponding word in the foreign language. However, such techniques may miss occurrences of synonyms of the words of the search term in the native language or the corresponding translated words in the foreign language. Additionally, if a conventional application does not possess a translation of the first word into a corresponding word in the foreign language, then the application may be unable to accurately search the audio recording. Therefore, conventional techniques may not accurately detect instances of a search term in a native language and its equivalents in an audio recording in the foreign language.

In accordance with the techniques of the disclosure, a system includes an input device which receives a first key phrase in a first language and an audio recording of speech in a second language different from the first language. The first key phrase may include a single word or multiple words. The system includes a language conversion unit which converts the first key phrase into a second key phrase in the second language. The second key phrase may include a single word or multiple words in the second language. The system further includes a word variation unit, which processes the second key phrase to produce a second key phrase variant. In some examples, a word of the second key phrase and a word of the second key phrase variant belong to a same classification.

The system includes a speech recognition unit which processes the audio recording to generate a searchable lattice of words in the second language. In some examples where the language conversion unit does not possess a translation for, e.g., a first word of the first key phrase, the language conversion unit may perform a machine translation of the first word into the second language and generate a pronunciation of the machine translation which may aid the system in constructing a searchable lattice of the audio recording. A query unit of the system queries the lattice to identify instances of the second key phrase or the second key phrase variant within the audio recording. An output device of the system outputs, for presentation to a user, the identified instances of the second key phrase or the second key phrase variant within the audio recording to enhance searchability of the audio recording of speech in the second language.

The techniques of the disclosure may provide specific improvements to the computer-related field of machine translation and searching of audio recordings in foreign languages that have practical applications. For example, the techniques of the disclosure may improve the accuracy of the results obtained by a system searching for the presence of a key phrase in a first language within an audio recording in a second language. Additionally, the techniques of the disclosure may enable such a system to generate a translation and pronunciation of a word in the first language for which the system does not have a corresponding translation in the second language, such that the system may still generate searchable phrases with which the audio recording may be searched. Also, the techniques of the disclosure may enable a system to identify more relevant instances of a key phrase of interest from an audio recording. The techniques of the disclosure may additionally enable a user to accurately search for instances of a key phrase within an audio recording of a language not spoken by the user. Furthermore, the techniques of the disclosure may enable a system to improve the recall, performance, and usability of searching audio recordings of speech in a foreign language. Therefore, the techniques of the disclosure may enable a system to enhance the searchability of an audio recording of speech in a second language with a key phrase in a first language.

In one example, this disclosure describes a system comprising: an input device configured to: receive a first key phrase in a first language; and receive an audio recording of speech in a second language different from the first language; a language conversion unit executed by the processing circuitry, the language conversion unit configured to convert the first key phrase into a second key phrase in the second language; a word variation unit executed by processing circuitry, the word variation unit configured to process the second key phrase to produce a second key phrase variant in the second language, wherein the second key phrase variant belongs to a same classification as a classification of the second key phrase; a speech recognition unit configured to process the audio recording to generate a graph of words in the second language; a query unit configured to query the graph to identify instances of the second key phrase or the second key phrase variant within the audio recording; and an output device configured to output the identified instances of the second key phrase or the second key phrase variant within the audio recording to enhance searchability of the audio recording of speech in the second language.

In another example, this disclosure describes a method comprising: receiving, by processing circuitry of a computing system, a first key phrase in a first language; converting, by the processing circuitry, the first key phrase into a second key phrase in a second language different from the first language; processing, by the processing circuitry, the second key phrase to produce a second key phrase variant in the second language, wherein the second key phrase variant belongs to a same classification as a classification of the second key phrase; receiving, by the processing circuitry, an audio recording of speech in the second language; processing, by the processing circuitry, the audio recording to generate a graph of words in the second language; querying, by the processing circuitry, the graph to identify instances of the second key phrase or the second key phrase variant within the audio recording; and outputting, by the processing circuitry, the identified instances of the second key phrase or the second key phrase variant within the audio recording to enhance searchability of the audio recording of speech in the second language.

In another example, this disclosure describes a non-transitory, computer-readable medium comprising instructions that, when executed, are configured to cause processing circuitry of a computing system to: receive a first key phrase in a first language; convert the first key phrase into a second key phrase in a second language different from the first language; process the second key phrase to produce a second key phrase variant in the second language, wherein the second key phrase variant belongs to a same classification as a classification of the second key phrase; receive an audio recording of speech in the second language; process the audio recording to generate a graph of words in the second language; query the graph to identify instances of the second key phrase or the second key phrase variant within the audio recording; and output the identified instances of the second key phrase or the second key phrase variant within the audio recording to enhance searchability of the audio recording of speech in the second language.

In another example, this disclosure describes a method comprising: receiving, by processing circuitry of a computing system, a first key phrase in a first language; converting, by the processing circuitry, the first key phrase into a second key phrase in a second language different from the first language, the converting comprising: determining that the computing system does not include a second word in the second language corresponding to a first word of the first key phrase; performing machine translation of the first word of the first key phrase to obtain the second word in the second language; generating a machine pronunciation of the second word in the second language; and storing, in a pronunciation dictionary, the machine pronunciation of the second word; receiving, by the processing circuitry, an audio recording of speech in the second language; processing, by the processing circuitry and based at least in part on the pronunciation dictionary, the audio recording to generate a graph of words in the second language; querying, by the processing circuitry, the graph to identify instances of the second key phrase within the audio recording; and outputting, by the processing circuitry, the identified instances of the second key phrase within the audio recording to enhance searchability of the audio recording of speech in the second language.

In another example, this disclosure describes a non-transitory, computer-readable medium comprising instructions that, when executed, are configured to cause processing circuitry of a computing system to: receive a first key phrase in a first language; convert the first key phrase into a second key phrase in a second language different from the first language, the converting comprising: determining that the computing system does not include a second word in the second language corresponding to a first word of the first key phrase; performing machine translation of the first word of the first key phrase to obtain the second word in the second language; generating a machine pronunciation of the second word in the second language; and storing, in a pronunciation dictionary, the machine pronunciation of the second word; receive an audio recording of speech in the second language; process, based at least in part on the pronunciation dictionary, the audio recording to generate a graph of words in the second language; query the graph to identify instances of the second key phrase within the audio recording; and output the identified instances of the second key phrase within the audio recording to enhance searchability of the audio recording of speech in the second language.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example system for searching for the presence of a key phrase in a first language within an audio recording of a second language, in accordance with the techniques of the disclosure.

FIG. 2A is a block diagram illustrating an example computing device in accordance with the techniques of the disclosure.

FIG. 2B is a block diagram illustrating an example distributed computing system in accordance with the techniques of the disclosure.

FIG. 3 is a flow chart illustrating an example operation in accordance with the techniques of the disclosure.

FIG. 4 is a flow chart illustrating an example operation in accordance with the techniques of the disclosure.

Like reference characters refer to like elements throughout the figures and description.

### DETAILED DESCRIPTION

Users of keyword detection technology have a keen interest in finding all instances of a word or phrase of interest in a given audio recording, referred to as “recall.” Conventional systems suffer from several factors that limit the recall of keyword detection for users. For example, some or all words of interest may not be present within the underlying speech recognition vocabulary, e.g., such words are “out-of-vocabulary” (OOV) words. Also, a query word or phrase (also referred to herein as a “keyword” or “key phrase”) may not be present within the recognition output, although a closely-related variant (e.g., a synonym) may be present. Additionally, recall may be limited where a query word is not detected within an audio recording because it is not sufficiently distinct from noise within the audio recording (e.g., a low signal-to-noise ratio). Such factors may limit the keyword detection performance of conventional systems. As used herein, a “phrase” and variants thereof denotes one or more words.

If a word is an OOV word, a conventional system may not offer a remedy to the user other than adding the word of interest to a recognition dictionary such that the word is no longer an OOV word. For example, if a dictionary includes the word “walk” but not other forms of the word, the user could add variants to a keyword list by manually adding all related forms of the word (e.g., the words “walks,” “walking,” “walked,” etc.). However, this is a tedious process that is subject to error. Furthermore, this may be impractical where the language includes many different declensions, tenses, or conjugations or where synonyms may be of interest (e.g., “amble,” “stroll,” “jaunt,” “meander,” “traipse,” etc.). Additionally, manually entering additional words to a keyword list may be impossible where the user does not speak the language of interest, such as the case where the user desires to search for a foreign language.

In some scenarios, a user who speaks a native language may desire to search for the presence of a keyword or key phrase within an audio recording of a foreign language that the user does not speak. In conventional systems, the detection of keywords in a foreign language is of limited use to a user who is not knowledgeable in that language. Those users are limited both by being unable to generate keywords of interest within the foreign language, as well as being unaware of which foreign language keywords were (or were not) detected in the foreign language audio recording. For example, if a user desires to search for the presence of a first word within an audio recording of a foreign language, he or she may be unaware as to whether, e.g., words and phrases having similar classifications such as synonyms of the key phrase were (or were not) searched within the audio recording. Such factors may limit the keyword detection usability of conventional systems.

Conventional systems may therefore require a user to rely upon foreign language speakers to manually write a keyword list that can be used within a foreign language keyword detection system, and then manually translate detected keywords back into the native language of the user to understand which words were actually detected. This process is time-intensive, cumbersome, and expensive. Furthermore, it may be impractical or undesirable to involve a native speaker in translation of the audio recording, especially where the audio recording may pertain to confidential, proprietary, or sensitive information.

In accordance with the techniques of the disclosure, a system is described herein which may search for the presence of a key phrase in a first language within an audio recording of a second language, even where the key phrase includes one or more OOV words. For example, a system receives a key phrase comprising one or more words from a user at runtime. For a word of the key phrase that are OOV words with respect to the underlying recognition dictionary, the system may perform a machine translation of the OOV word into the second language and generate a pronunciation of the translated word in the second language. In some examples, the system uses autopronunciation techniques (also referred to as “autopron”) to generate the pronunciation of the translated word in the second language. An example of autopron software with which the techniques of the disclosure may be implemented is Phonetisaurus, available from https://github.com/AdolfVonKleist/Phonetisaurus (accessed on Jun. 16, 2022). The system further dynamically adds the translated word in the second language and its generated pronunciation to the recognition dictionary. Thereafter, the system may query the audio recording in the second language with the translated word in the second language and its generated pronunciation. In this fashion, the system may search for the presence of a key phrase in a first language within an audio recording of a second language, even where the key phrase includes one or more OOV words. Such a system as described herein is a novel combination of technologies which enables dynamic keyword lists with any vocabulary.

In some examples, a system as described herein may augment one or more words of the key phrase with word variants for improved keyword detection performance. For example, to find a key phrase of interest within an audio recording in a second language, the system described herein may query the audio recording with not only a translation of the original key phrase, but also a set of variant words of the translation of the original key phrase, to the extent available. In some examples, the system may identify variant words from a list of similar words ordered by frequency of use, classification, or synonyms. In some examples, another metric not expressly disclosed may be used to identify words that are variants to the words of the key phrase. In some examples, the user may control a maximum number of variants of the words of the key phrase to be used by the system in searching the audio recording.

In some examples, the system described herein may receive a key phrase in a first language, translate the key phrase into a second language, generate one or more variants in the second language from the translated key phrase, and query an audio recording in the second language with the one or more variants in the second language and the translation of the key phrase. In alternative examples, the system described herein may receive a key phrase in a first language, generate one or more variants in the first language from the key phrase, translate the key phrase and the one or more variants into a second language, and query an audio recording in the second language with the translations of the key phrase and the one or more variants.

What may be considered to be a variant of a word of a ley phrase may be language-dependent, and may largely overlap with morphological relatedness. For example, given an English noun, its singular and plural forms may be variants. As another example, given an English verb, its present or past tenses may be variants. In some examples, a full morphological analyzer may be used to construct a list of variants. However, such analyzers may be infeasible to build. In other examples, the system described herein may use stemmed text corpora to generate variants. Such a stemmed text corpora may approximate the behavior of a morphological analyzer in many cases, while being much less complex to implement. In other examples, the system described herein may identify variants of a word of a key phrase based on semantic relatedness, phonetic distance, etc.

In some examples, the system described herein may provide improved performance of keyword detection. A conventional system may perform keyword detection by generating an output speech recognition lattice from an audio recording, and searching the lattice for the presence of a keyword or key phrase. The system described herein may first rescoring the lattice using a higher-order language model. In addition or in the alternative, the system described herein may use recognition and rescoring language models which have been “boosted” to increase keyword probabilities. In this fashion, the system described herein may improve performance of keyword detection over conventional techniques.

In some examples, a system as described herein may provide enhanced key phrase detection usability. For example, rather than a monolingual keyword list, the system described herein may use a bilingual keyword list to operate foreign language keyword detection. In some examples, the system uses machine translation to obtain missing forms of a word prior to performing foreign language keyword recognition of an audio recording in the foreign language. For example, in a French keyword detection system, if a bilingual English-French translation dictionary of the system includes the word “house” in English with no corresponding French form, then the system performs English-to-French machine translation to obtain the French word “maison.” The system subsequently may search an audio recording in French for the presence of the word “maison.” Conversely, if the bilingual English-French translation dictionary of the system contains the French word “maison” with no equivalent English term, then the system performs French-to-English machine translation to obtain the term “house.” As a result, upon detection of the term “maison” within the audio recording in French, the system may display, to an English-speaking user, that an instance of the English word “house” occurs within the audio recording.

In some examples, the system performs machine translation only where the bilingual English-French translation dictionary does not include a corresponding word in the opposite language. That is, if the translation dictionary already includes a French translation for the English word “house,” (as, for instance, supplied by a French speaker), the system gives precedence to the pre-existing translation over any machine translation that would otherwise be obtained. This ensures that user-vetted keyword correspondence pairs are not replaced by machine translation results, which may be less accurate. As a result, the approach of the system disclosed herein may flexibly accommodate bilingual keyword list scenarios, e.g., where no English-to-French or French-to-English translations are provided, where all English-to-French or French-to-English translations are user-supplied, or any scenario in between. Importantly, while the foregoing example includes a single word, the approach of the system disclosed herein may generalize such techniques to search terms of any length, and therefore may perform more complicated phrase identification well beyond a simple word-based lookup table.

The techniques disclosed herein are more comprehensive than conventional techniques, and furthermore, may combine techniques for OOV addition and lattice boosting in a fully automatic fashion without any need for explicit user input. Therefore, the system described herein may provide enhanced searchability of audio recordings in a different language than the key phrase to be searched.

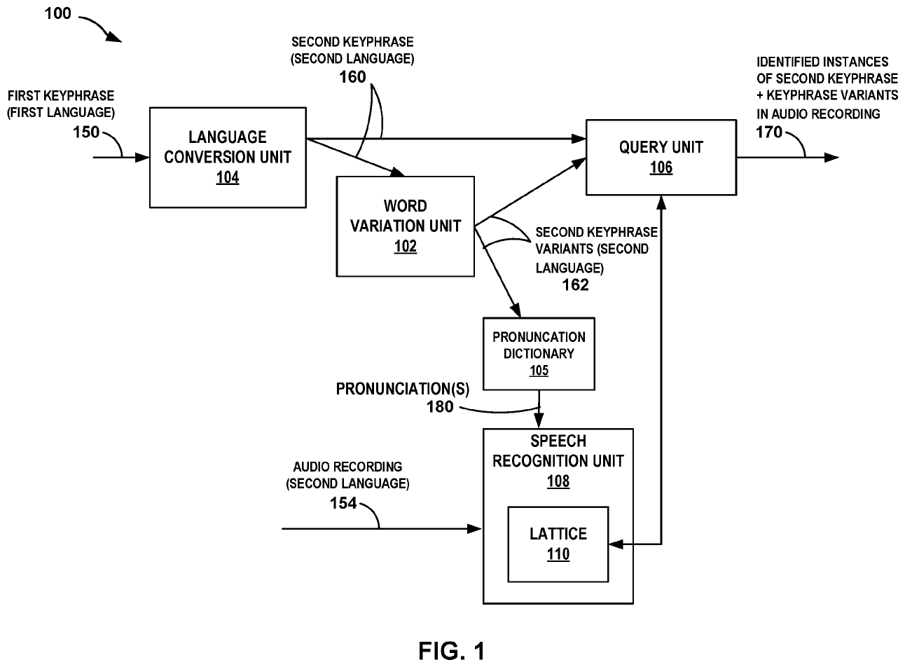

FIG. 1 is a block diagram illustrating example system 100 for searching for the presence of a key phrase in a first language within an audio recording of a second language, in accordance with the techniques of the disclosure. In the example of FIG. 1, system 100 includes word variation unit 102, language conversion unit 104, query unit 106, and speech recognition unit 108. System 100 receives first key phrase 150 in a first language and searches audio recording 154 of a second language, and produces identified instances 170 in the second language of the first key phrase 150 that occur within audio recording 154. In some examples, one or more components of system 100 are implemented within a computer, such as a desktop system, a mobile phone or “smart” phone, a laptop, a tablet computer, a personal digital assistant (PDA), or the like. In some examples, one or more components of system 100 are implemented across a distributed computing architecture, which may include a cloud computing system.

In accordance with the techniques of the disclosure, language conversion unit 104 receives first key phrase 150. First key phrase 150 comprises one or more words in a first language. Language conversion unit 104 converts first key phrase 150 in the first language into second key phrase 160 in a second language. Second key phrase 160 comprises one or more words in the second language. In some examples, the first language is English. In some examples, the second language is Arabic, Russian, or Chinese.

Word variation unit 102 of system 100 receives second key phrase 160 from language conversion unit 104. Word variation unit 102 processes second key phrase 160 to produce one or more second key phrase variants 162. Each second key phrase variant 162 comprises one or more words in the second language. In some examples, each second key phrase variant 162 include at least one word that is different from a word of second key phrase 160 and each other second key phrase variant 162.

In some examples, each of the words of second key phrase 160 and the corresponding words of second key phrase variant 162 belong to a same classification. As described herein, a same classification refers to a same category, grouping, set, class, etc. For example, the classification may be a morphology-based grouping. Word variation unit 102, in some examples, applies a stemming operation to a word of second key phrase 160 to obtain the corresponding word of second key phrase variant 162. As an example wherein the word of second key phrase 160 is the English word “walk,” word variation unit 102 applies a stemming operation to obtain the morphological variants “walks,” “walking,” “walked,” etc. In some examples, word variation unit 102 applies a stemming operation to each word of second key phrase 160 to obtain morphological variants of the word, such as different declensions, tenses, or conjugations of the word of second key phrase 160.

As another example, the classification may be a semantic-based grouping. As an example wherein the word of second key phrase 160 is the English word “walk,” word variation unit 102 may obtain semantic variants “amble,” “stroll,” “jaunt,” “meander,” “traipse,” or other synonyms of the word. In other examples, word variation unit 102 may obtain other types of classifications, semantic or otherwise. For example, given the word “rectangle,” word variation unit 102 may identify words sharing a similar geometric classification, such as “square,” “diamond,” “rhombus,” etc. In other examples, given the word “car,” word variation unit 102 may identify words sharing an “automobile” classification,” such as “truck,” “motorcycle,” “sedan,” etc. In some examples, a user may control the precision with which word variation unit 102 matches the first word to a classification. For example, while a “rectangle” may not precisely be considered to be a “diamond” or a “truck” may or may not be considered a “car,” such a “fuzzy” match may be of relevance to the user, particularly in the scenario wherein the user is searching for the presence of terms in a first language within an audio recording of a second language, and strict or exact translations may not capture relevant instances of the queried key phrase within the audio recording.

System 100 further includes phonetic dictionary 105, which includes an entry for each word known in the second language and a pronunciation of the word in the second language. As described in detail below, speech recognition unit 108 may use the pronunciation of the word in the second language to process audio recording 154 into lattice 110. However, in some examples, phonetic dictionary 105 may not possess a corresponding pronunciation for a word in the second language, e.g., a pronunciation of a word of second key phrase variant 162. In this example, phonetic dictionary 105 generates a pronunciation of the word in the second language that is usable by speech recognition unit 108 for process audio recording 154 into lattice 110. In some examples, phonetic dictionary 105 uses autopron to generate the pronunciation of the word in the second language. Phonetic dictionary 105 stores an entry comprising the word in the second language and the pronunciation of the word in the second language. Speech recognition unit 108 may thereafter use the pronunciations stored by phonetic dictionary 105, including the pronunciation of the word in the second language, to construct lattice 110 from audio recording 154. Such techniques may also be performed for pronunciations of words generated by machine translation of first key phrase 150, to the extent necessary.

Speech recognition unit 108 processes audio recording 154 in the second language to generate a graph of words in the second language. As depicted in the example of FIG. 1, the graph is in the form of a lattice 110 of words in the second language. In some examples, speech recognition unit 108 receives and interprets an audio recording of, e.g., speech or one or more voices during a conversation session. In some examples, speech recognition unit 108 may produce individual sound waveforms, textual representations, or any combination of both, such as phrases, individual words, phonemes, non-words, and any combination, which may be stored in lattice 110.

Lattice 110 provides a searchable graph of predicted transcriptions for audio recording 154. Typically, lattice 110 represents rankings of likely transcriptions of audio recording 154 into recognized words, sub-words, or phenomes which are organized into most likely occurring sequences. While the example of FIG. 1 depicts the use of lattice 110, in other examples the techniques of the disclosure may be implemented using different types of data structures. For example, speech recognition unit 108 may construct a graph, a lattice, or another type of data structure not expressly described herein.

Query unit 106 receives, from language conversion unit 104, second key phrase 160 and the one or more second key phrase variants 162. Query unit 106 queries lattice 110 to identify instances 170 of second key phrase 160 or the one or more second key phrase variants 162 within audio recording 154. System 100 may thereafter output, for presentation to a user, the identified instances 170 of second key phrase 160 or the one or more second key phrase variants 162 within audio recording 154 to enhance searchability of audio recording 154 in the second language.

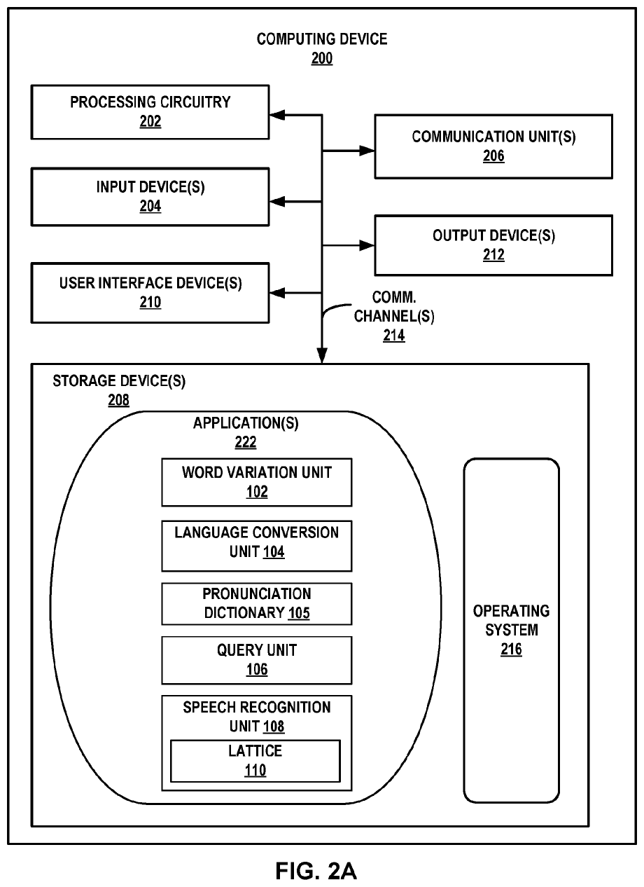

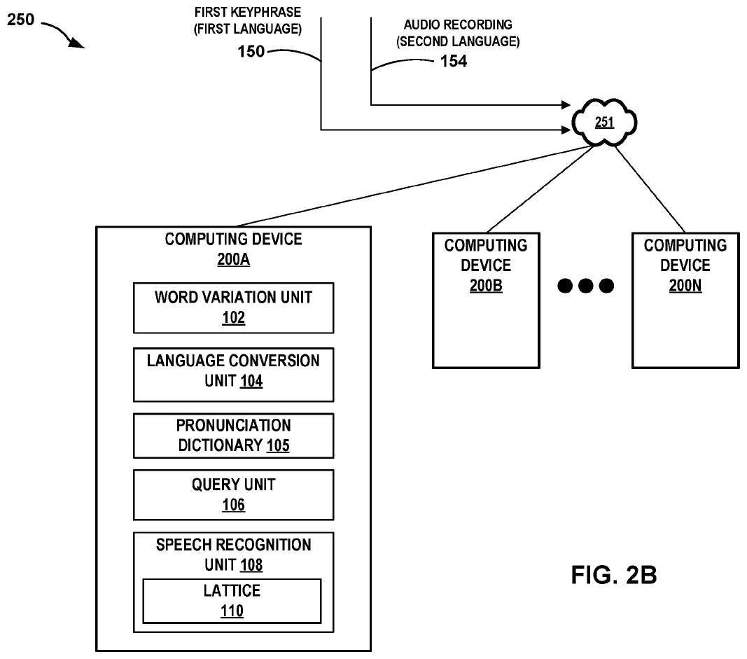

FIG. 2A is a block diagram illustrating an example computing device 200 in accordance with the techniques of the disclosure. In general, computing device 200 may be an example implementation of system 100 of FIG. 1. FIG. 2A illustrates a particular example of computing device 200 that includes processing circuitry 202 for executing any one or more of applications 222 or any other computing device described herein. Other examples of computing device 200 may be used in other instances.

Although shown in FIG. 2A as a stand-alone computing device 200 for purposes of example, a stand-alone or distributed computing system that operates in accordance with the techniques of this disclosure may be any component or system that includes one or more processors or other suitable computing environment for executing software instructions and, for example, need not necessarily include one or more elements shown in FIG. 2A (e.g., communication units 206; and in some examples, components such as storage device(s) 208 may not be co-located or in the same chassis as other components). An example of a distributed computing system that operates in accordance with the techniques of this disclosure is set forth below with respect to FIG. 2B.

As shown in the example of FIG. 2A, computing device 200 includes processing circuitry 202, one or more input devices 204, one or more communication units 206, one or more output devices 212, one or more storage devices 208, and one or more user interface (UI) device(s) 210. Computing device 200, in one example, further includes one or more application(s) 222 and operating system 216 that are executable by computing device 200. Each of components 202, 204, 206, 208, 210, and 212 are coupled (physically, communicatively, and/or operatively) for inter-component communications. In some examples, communication channels 214 may include a system bus, a network connection, an inter-process communication data structure, or any other method for communicating data. As one example, components 202, 204, 206, 208, 210, and 212 may be coupled by one or more communication channels 214.

Processing circuitry 202, in one example, are configured to implement functionality and/or process instructions for execution within computing device 200. In some examples, processing circuitry 202 comprises one or more hardware-based processors. For example, processing circuitry 202 may be capable of processing instructions stored in storage device 208. Examples of processing circuitry 202 may include, any one or more of a microprocessor, a controller, a digital signal processor (DSP), an application specific integrated circuit (ASIC), a field-programmable gate array (FPGA), or equivalent discrete or integrated logic circuitry.

One or more storage devices 208 may be configured to store information within computing device 200 during operation. Storage device 208, in some examples, is described as a computer-readable storage medium. In some examples, storage device 208 is a temporary memory, meaning that a primary purpose of storage device 208 is not long-term storage. Storage device 208, in some examples, is described as a volatile memory, meaning that storage device 208 does not maintain stored contents when the computer is turned off. Examples of volatile memories include random access memories (RAM), dynamic random access memories (DRAM), static random access memories (SRAM), and other forms of volatile memories. In some examples, storage device 208 is used to store program instructions for execution by processing circuitry 202. Storage device 208, in one example, is used by software or applications running on computing device 200 to temporarily store information during program execution.

Storage devices 208, in some examples, also include one or more computer-readable storage media. Storage devices 208 may be configured to store larger amounts of information than volatile memory. Storage devices 208 may further be configured for long-term storage of information. In some examples, storage devices 208 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 200, in some examples, also includes one or more communication units 206. Computing device 200, in one example, utilizes communication units 206 to communicate with external devices via one or more networks, such as one or more wired/wireless/mobile networks. Communication units 206 may include a network interface, such as an Ethernet card, an optical transceiver, a radio frequency transceiver, or any other type of device that can send and receive information. Other examples of such network interfaces may include 3G and WiFi radios. In some examples, computing device 200 uses communication unit 206 to communicate with an external device.

Computing device 200, in one example, also includes one or more user interface devices 210. User interface devices 210, in some examples, are configured to receive input from a user through tactile, audio, or video feedback. Examples of user interface devices(s) 210 include a presence-sensitive display, a mouse, a keyboard, a voice responsive system, video camera, microphone or any other type of device for detecting a command from a user. In some examples, a presence-sensitive display includes a touch-sensitive screen. In some examples, a user may enter configuration data for computing device 200.

One or more output devices 212 may also be included in computing device 200. Output device 212, in some examples, is configured to provide output to a user using tactile, audio, or video stimuli. Output device 212, in one example, includes a presence-sensitive display, a sound card, a video graphics adapter card, or any other type of device for converting a signal into an appropriate form understandable to humans or machines. Additional examples of output device 212 include a speaker, a cathode ray tube (CRT) monitor, a liquid crystal display (LCD), or any other type of device that can generate intelligible output to a user.

Computing device 200 may include operating system 216. Operating system 216, in some examples, controls the operation of components of computing device 200. For example, operating system 216, in one example, facilitates the communication of one or more applications 222 with processing circuitry 202, communication unit 206, storage device 208, input device 204, user interface devices 210, and output device 212. Applications 222 may also include program instructions and/or data that are executable by computing device 200.

In accordance with the techniques of the disclosure, applications 22 include word variation unit 102, language conversion unit 104, query unit 106, and speech recognition unit 108, which may operate in substantially similar fashion to like elements of FIG. 1. For example, language conversion unit 104 receives first key phrase 150. First key phrase 150 comprises one or more first words in a first language. In some examples, first key phrase 150 comprises a text string and is received from a user via input devices 204.

Language conversion unit 104 converts first key phrase 150 in the first language into second key phrase 160 in a second language. Second key phrase 160 comprises one or more second words in the second language. In some examples, language conversion unit 104 translates first key phrase 150 in the first language into second key phrase 160 in a second language, such as by performing machine translation.

Word variation unit 102 processes second key phrase 160 to produce one or more second key phrase variants 162. Each second key phrase variant 162 comprises one or more third words in the second language. In some examples, each of the second words of second key phrase 160 and the corresponding third words of second key phrase variant 162 belong to a same classification.

Phonetic dictionary 105 includes an entry for each word known in the second language and a pronunciation of the word in the second language. As described in detail below, speech recognition unit 108 may use the pronunciation of the word in the second language to process audio recording 154 into lattice 110. However, in some examples, phonetic dictionary 105 may not possess a corresponding pronunciation for a word in the second language, e.g., a pronunciation of a word of second key phrase variant 162. In this example, phonetic dictionary 105 generates a pronunciation of the word in the second language that is usable by speech recognition unit 108 for process audio recording 154 into lattice 110. In some examples, phonetic dictionary 105 uses autopron to generate the pronunciation of the word in the second language. Phonetic dictionary 105 stores an entry comprising the word in the second language and the pronunciation of the word in the second language. Speech recognition unit 108 may thereafter use the pronunciations stored by phonetic dictionary 105, including the pronunciation of the word in the second language, to construct lattice 110 from audio recording 154. Such techniques may also be performed for pronunciations of words generated by machine translation of first key phrase 150, to the extent necessary.

Speech recognition unit 108 processes audio recording 154 in the second language to generate a graph of words in the second language. As depicted in the example of FIG. 2A, the graph is in the form of a lattice 110 of words in the second language. In some examples, speech recognition unit 108 receives and interprets an audio recording of, e.g., speech or one or more voices during a conversation session. In some examples, speech recognition unit 108 may produce individual sound waveforms, textual representations, or any combination of both, such as phrases, individual words, phonemes, non-words, and any combination, which may be stored in lattice 110.

Lattice 110 provides a searchable graph of predicted transcriptions for audio recording 154. Typically, lattice 110 represents rankings of likely transcriptions of audio recording 154 into recognized words, sub-words, or phenomes which are organized into most likely occurring sequences. While the example of FIG. 1 depicts the use of lattice 110, in other examples the techniques of the disclosure may be implemented using different types of data structures. For example, speech recognition unit 108 may construct a graph, a lattice, or another type of data structure not expressly described herein.

In some examples, speech recognition unit 108 applies a first speech recognition model to audio recording 154 to generate an intermediate lattice of words in the second language. Further, speech recognition unit 108 applies a second speech recognition model to the intermediate lattice to generate lattice 110 of words in the second language. In some examples, a complexity of the first speech recognition model is lower than a complexity of the second speech recognition model. The use of multiple speech recognition models of varying complexity may reduce the computational requirements of processing audio recording 154 with a complex speech recognition model, while providing enhanced precision and accuracy over the use of a low-complexity speech recognition model, thereby providing computing device 200 with the benefits of both types of models.

Query unit 106 receives, from language conversion unit 104, second key phrase 160 and the one or more second key phrase variants 162. Query unit 106 queries lattice 110 to identify instances 170 of second key phrase 160 or the one or more second key phrase variants 162 within audio recording 154.

Output devices 212 output, for presentation to a user, the identified instances 170 of second key phrase 160 or the one or more second key phrase variants 162 within audio recording 154 to enhance searchability of audio recording 154 in the second language. In some examples, output devices 212 further output, for presentation to the user, an indication of a time at which each of the identified instances 170 of second key phrase 160 or the one or more second key phrase variants 162 occur within audio recording 154. In some examples, output devices 212 further output, for presentation to the user, a count of the instances 170 of second key phrase 160 or the one or more second key phrase variants 162 identified within audio recording 154.

FIG. 2B is a block diagram illustrating an example distributed computing system 250 in accordance with the techniques of the disclosure. In FIG. 2B, system 300 includes computing devices 200A-200N (hereinafter, “computing devices 200”) communicably coupled through network 251. Each of computing devices 200 may operate in a substantially similar fashion to computing device 200 of FIG. 2B. For ease of illustration, only one computing device 200A is illustrated in FIG. 2B, although techniques in accordance with one or more aspects of this disclosure may be performed with many more of such systems or devices. Further, although illustrated as communicating through network 251, in other examples, one or more computing devices 200 may be directly connected or combined. As depicted in the example of FIG. 2B, the functionality of computing device 200 of FIG. 2A is distributed across multiple computing devices 200, which form computing system 250. In general, system 250 of FIG. 2B may be described as an example or alternative implementation of system 100 of FIG. 1 or computing device 200 of FIG. 2A, and one or more aspects of FIG. 2B may be described herein within the context of FIG. 1A and/or FIG. 1C.

Network 251 may be the internet, or may include or represent any public or private communications network or other network. For instance, network 251 may be a cellular, Wi-Fi®, ZigBee, Bluetooth, Near-Field Communication (NFC), satellite, enterprise, service provider, and/or other type of network enabling transfer of transmitting data between computing systems, servers, and computing devices. One or more of client devices, server devices, or other devices may transmit and receive data, commands, control signals, and/or other information across network 251 using any suitable communication techniques. Network 251 may include one or more network hubs, network switches, network routers, satellite dishes, or any other network equipment. Such devices or components may be operatively inter-coupled, thereby providing for the exchange of information between computers, devices, or other components (e.g., between one or more client devices or systems and one or more server devices or systems). Each of the devices or systems illustrated in FIG. 2B may be operatively coupled to network 251 using one or more network links. The links coupling such devices or systems to network 251 may be Ethernet, Asynchronous Transfer Mode (ATM) or other types of network connections, and such connections may be wireless and/or wired connections. One or more of the devices or systems illustrated in FIG. 2B or otherwise on network 251 may be in a remote location relative to one or more other illustrated devices or systems.

Computing system 250 may serve as a machine learning system, and each of computing devices 200 of computing system 250 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, computing system 250 may be an example or alternative implementation of computing system 200 of FIG. 2A. In some examples, computing system 250 represents a cloud computing system, server farm, and/or server cluster (or portion thereof) that provides services to client devices and other devices or systems. In other examples, computing system 250 may represent or be implemented through one or more virtualized compute instances (e.g., virtual machines, containers) of a data center, cloud computing system, server farm, and/or server cluster.

One or more processors (not depicted in FIG. 2B) of computing device 200A may implement functionality and/or execute instructions associated with computing system 250 or associated with one or more modules illustrated herein and/or described below. One or more processors may be, may be part of, and/or may include processing circuitry that performs operations in accordance with one or more aspects of the present disclosure. Examples of processors include microprocessors, application processors, display controllers, auxiliary processors, one or more sensor hubs, and any other hardware configured to function as a processor, a processing unit, or a processing device. Computing device 200A may use one or more processors to perform operations in accordance with one or more aspects of the present disclosure using software, hardware, firmware, or a mixture of hardware, software, and firmware residing in and/or executing at computing device 200A.

One or more storage devices (not depicted in FIG. 2B) of computing device 200A may include temporary memories, meaning that a primary purpose of the one or more storage devices is not long-term storage. The storage devices of computing device 200A may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. The storage devices of computing device 200A, in some examples, also include one or more computer-readable storage media. The storage devices of computing device 200A may be configured to store larger amounts of information than volatile memory. The storage devices of computing device 200A may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories.

Modules illustrated in FIG. 2B (e.g., word variation unit 102, language conversion unit 104, pronunciation dictionary 105, query unit 106, and speech recognition unit 108) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

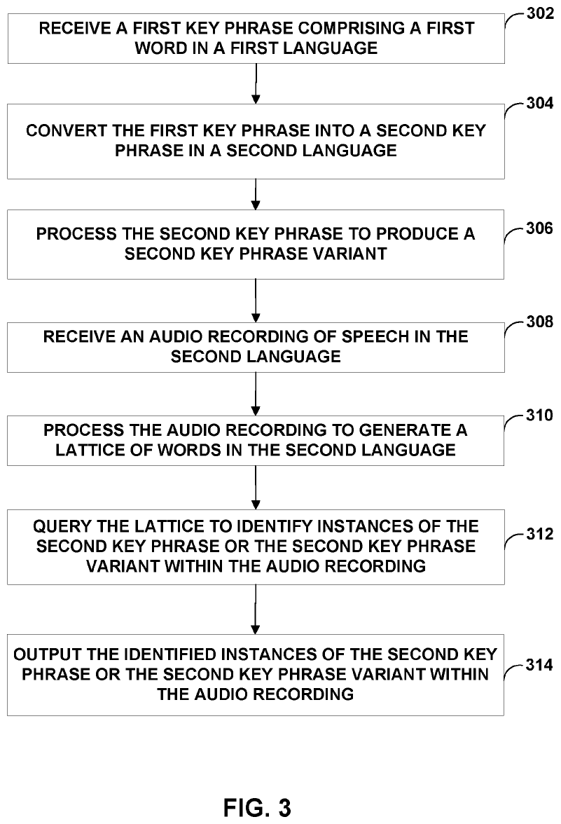

FIG. 3 is a flow chart illustrating an example operation in accordance with the techniques of the disclosure. For convenience, FIG. 3 is described with respect to computing device 200 of FIG. 2A. However, the operation of FIG. 3 may additionally be performed by system 100 of FIG. 1 or computing devices 200 of FIG. 2B.

As depicted in the example of FIG. 3, input devices 204 receive, from a user, first key phrase 150 (302). First key phrase 150 comprises a first word in a first language. Language conversion unit 104 translates first key phrase 150 in the first language into second key phrase 160 (304). Second key phrase 160 comprises a second word in the second language. Word variation unit 102 processes second key phrase 160 to produce second key phrase variant 162 (306). Second key phrase variant 162 comprises a third word in the second language. In some examples, the second word of second key phrase 160 and the third word of second key phrase variant 162 belong to a same classification. In some examples, word variation unit 102 applies a stemming operation to the second word of second key phrase 160 to obtain the third word of second key phrase variant 162.

Input devices 204 receive, from a user, audio recording 154 of speech in the second language (308). Speech recognition unit 108 processes audio recording 154 in the second language to generate lattice 110 of words in the second language (310). Query unit 106 queries lattice 110 to identify instances 170 of second key phrase 160 or second key phrase variant 162 within audio recording 154 (312). Output devices 212 output, for presentation to a user, the identified instances 170 of second key phrase 160 or the one or more second key phrase variants 162 within audio recording 154 to enhance searchability of audio recording 154 in the second language (314).

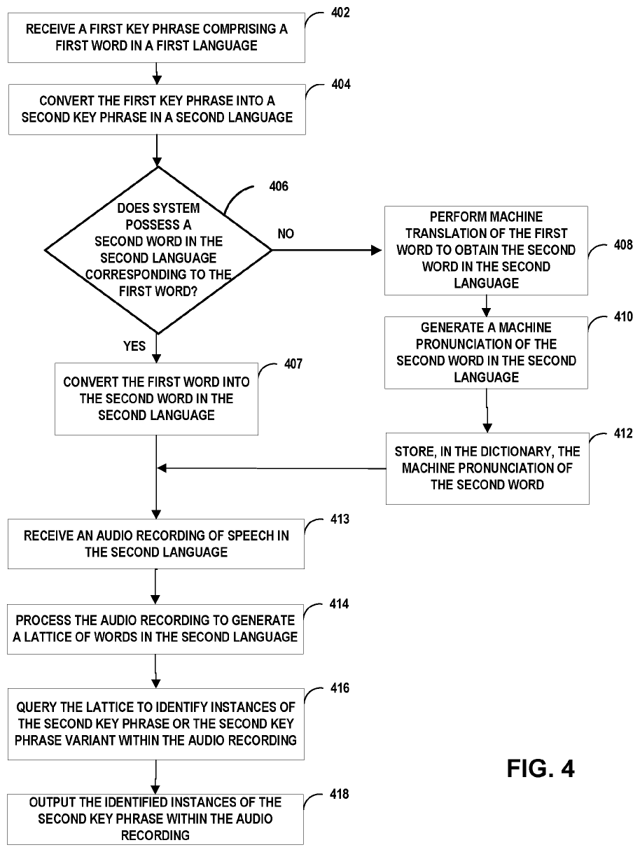

FIG. 4 is a flow chart illustrating an example operation in accordance with the techniques of the disclosure. For convenience, FIG. 4 is described with respect to computing device 200 of FIG. 2A. However, the operation of FIG. 4 may additionally be performed by system 100 of FIG. 1 or computing devices 200 of FIG. 2B.

As depicted in the example of FIG. 4, input devices 204 receive, from a user, first key phrase 150 (402). First key phrase 150 comprises one or more first words in a first language. Language conversion unit 104 converts first key phrase 150 in the first language into second key phrase 160 (404). Second key phrase 160 comprises one or more second words in the second language.

In some examples, language conversion unit 104 may not necessarily possess a translation for, e.g., the one or more first words of first key phrase 150. In this example, as part of converting first key phrase 150 in the first language into second key phrase 160 in the second language, language conversion unit 104 determines whether language conversion unit 104 possesses a second word in the second language corresponding to a first word in the first language of first key phrase 150 (406). In response to determining that language conversion unit 104 possesses a second word in the second language corresponding to a first word in the first language of first key phrase 150 (“YES” block of element 406), language conversion unit 104 converts the first word of the first key phrase 150 in the first language into the second word of second key phrase 160 (407).

In response to determining that bilingual dictionary 105 of language conversion unit 104 does not include a word in the second language corresponding to a first word in the first language of first key phrase 150 (“NO” block of element 406), language conversion unit 104 performs machine translation of the first word to obtain a corresponding word in the second language (408). Further, language conversion unit 104 generates a machine pronunciation of the machine-translated word in the second language (410). Speech recognition unit 108 may use the machine pronunciation to aid in the creation of lattice 110. In some examples, language conversion unit 104 uses autopron to generate the pronunciation of the machine-translated word in the second language. Language conversion unit 104 stores, in phonetic dictionary 105, the pronunciation of the machine-translated word in the second language (412).

Input devices 204 receive, from a user, audio recording 154 of speech in the second language (413). Speech recognition unit 108 processes audio recording 154 in the second language to generate lattice 110 of words in the second language (414). In some examples, speech recognition unit 108 uses phonetic dictionary 105 to identify instances of syllables or words within audio recording 154. Query unit 106 queries lattice 110 to identify instances 170 of second key phrase 160 within audio recording 154 (416). Output devices 212 output, for presentation to a user, the identified instances 170 of second key phrase 160 within audio recording 154 to enhance searchability of audio recording 154 in the second language (418).

The following examples may illustrate one or more aspects of the disclosure.

Example 1. A system comprising: an input device configured to: receive a first key phrase in a first language; and receive an audio recording of speech in a second language different from the first language; a language conversion unit executed by the processing circuitry, the language conversion unit configured to convert the first key phrase into a second key phrase in the second language; a word variation unit executed by processing circuitry, the word variation unit configured to process the second key phrase to produce a second key phrase variant in the second language, wherein the second key phrase variant belongs to a same classification as a classification of the second key phrase; a speech recognition unit configured to process the audio recording to generate a graph of words in the second language; a query unit configured to query the graph to identify instances of the second key phrase or the second key phrase variant within the audio recording; and an output device configured to output the identified instances of the second key phrase or the second key phrase variant within the audio recording to enhance searchability of the audio recording of speech in the second language.

Example 2. The system of example 1, wherein to process the second key phrase to produce the second key phrase variant, the word variation unit is configured to apply a stemming operation to the second key phrase to obtain the second key phrase variant.

Example 3. The system of any of examples 1 through 2, wherein the classification of the second key phrase comprises a morphology-based grouping.

Example 4. The system of any of examples 1 through 2, wherein the classification of the second key phrase comprises a semantic-based grouping.

Example 5. The system of any of examples 1 through 4, wherein to convert the first key phrase into the second key phrase, the language conversion unit is configured to perform machine translation of the first key phrase to obtain the second key phrase.

Example 6. The system of any of examples 1 through 5, wherein to process the audio recording to generate the graph of words in the second language, the speech recognition unit is configured to: apply a first speech recognition model to the audio recording to generate an intermediate graph of words in the second language; and apply a second speech recognition model to the intermediate graph to generate the graph of words in the second language.

Example 7. The system of example 6, wherein a complexity of the first speech recognition model is lower than a complexity of the second speech recognition model.

Example 8. The system of any of examples 1 through 7, wherein the output device is further configured to output an indication of a time at which each of the identified instances of the second key phrase or the second key phrase variant occur within the audio recording.

Example 9. The system of any of examples 1 through 8, wherein the output device is further configured to output an indication of a count of the identified instances of the second key phrase or the second key phrase variant within the audio recording.

Example 10. The system of any of examples 1 through 9, wherein the first key phrase comprises a text string.

Example 11. The system of any of examples 1 through 10, wherein the first key phrase comprises a first plurality of words in the first language, wherein the second key phrase comprises a second plurality of words in the second language, and wherein the second key phrase variant comprises a third plurality of words in the second language.

Example 12. The system of any of examples 1 through 10, wherein the first key phrase comprises a first plurality of words in the first language, wherein the second key phrase comprises a second plurality of words in the second language, and wherein the second key phrase variant comprises a plurality of second key phrase variants, wherein each second key phrase variant of the plurality of second key phrase variants comprises a third plurality of words in the second language, the third plurality of words of each second key phrase variant different from the third plurality of words of each other second key phrase variant and the second plurality of words of the second key phrase.

Example 13. A method comprising: receiving, by processing circuitry of a computing system, a first key phrase in a first language; converting, by the processing circuitry, the first key phrase into a second key phrase in a second language different from the first language; processing, by the processing circuitry, the second key phrase to produce a second key phrase variant in the second language, wherein the second key phrase variant belongs to a same classification as a classification of the second key phrase; receiving, by the processing circuitry, an audio recording of speech in the second language; processing, by the processing circuitry, the audio recording to generate a graph of words in the second language; querying, by the processing circuitry, the graph to identify instances of the second key phrase or the second key phrase variant within the audio recording; and outputting, by the processing circuitry, the identified instances of the second key phrase or the second key phrase variant within the audio recording to enhance searchability of the audio recording of speech in the second language.

Example 14. The method of example 13, wherein processing the second key phrase to produce the second key phrase variant comprises applying a stemming operation to the second key phrase to obtain the second key phrase variant.

Example 15. The method of any of examples 13 through 14, wherein the classification of the second key phrase comprises a morphology-based grouping.

Example 16. The method of any of examples 13 through 14, wherein the classification of the second key phrase comprises a semantic-based grouping.

Example 17. The method of any of examples 13 through 16, wherein converting the first key phrase into the second key phrase comprises performing machine translation of the first key phrase to obtain the second key phrase.

Example 18. The method of any of examples 13 through 17, wherein processing the audio recording to generate the graph of words in the second language comprises: applying, by the processing circuitry, a first speech recognition model to the audio recording to generate an intermediate graph of words in the second language; and applying, by the processing circuitry, a second speech recognition model to the intermediate graph to generate the graph of words in the second language.

Example 19. The method of example 18, wherein a complexity of the first speech recognition model is lower than a complexity of the second speech recognition model.

Example 20. The method of any of examples 13 through 19, further comprising outputting, by the processing circuitry, an indication of a time at which each of the identified instances of the second key phrase or the second key phrase variant occur within the audio recording.

Example 21. The method of any of examples 13 through 20, further comprising outputting, by the processing circuitry, an indication of a count of the identified instances of the second key phrase or the second key phrase variant within the audio recording.

Example 22. The method of any of examples 13 through 21, wherein the first key phrase comprises a first plurality of words in the first language, wherein the second key phrase comprises a second plurality of words in the second language, and wherein the second key phrase variant comprises a plurality of second key phrase variants, wherein each second key phrase variant of the plurality of second key phrase variants comprises a third plurality of words in the second language, the third plurality of words of each second key phrase variant different from the third plurality of words of each other second key phrase variant and the second plurality of words of the second key phrase.

Example 23. A non-transitory, computer-readable medium comprising instructions that, when executed, are configured to cause processing circuitry of a computing system to: receive a first key phrase in a first language; convert the first key phrase into a second key phrase in a second language different from the first language; process the second key phrase to produce a second key phrase variant in the second language, wherein the second key phrase variant belongs to a same classification as a classification of the second key phrase; receive an audio recording of speech in the second language; process the audio recording to generate a graph of words in the second language; query the graph to identify instances of the second key phrase or the second key phrase variant within the audio recording; and output the identified instances of the second key phrase or the second key phrase variant within the audio recording to enhance searchability of the audio recording of speech in the second language.

Example 23. A method comprising: receiving, by processing circuitry of a computing system, a first key phrase in a first language; converting, by the processing circuitry, the first key phrase into a second key phrase in a second language different from the first language, the converting comprising: determining that the computing system does not include a second word in the second language corresponding to a first word of the first key phrase; performing machine translation of the first word of the first key phrase to obtain the second word in the second language; generating a machine pronunciation of the second word in the second language; and storing, in a pronunciation dictionary, the machine pronunciation of the second word; receiving, by the processing circuitry, an audio recording of speech in the second language; processing, by the processing circuitry and based at least in part on the pronunciation dictionary, the audio recording to generate a graph of words in the second language; querying, by the processing circuitry, the graph to identify instances of the second key phrase within the audio recording; and outputting, by the processing circuitry, the identified instances of the second key phrase within the audio recording to enhance searchability of the audio recording of speech in the second language.

Example 24. The method of example 23, wherein to process the audio recording to generate the graph of words in the second language, the processing circuitry is configured to: apply a first speech recognition model to the audio recording to generate an intermediate graph of words in the second language; and apply a second speech recognition model to the intermediate graph to generate the graph of words in the second language.

Example 25. The method of example 24, wherein a complexity of the first speech recognition model is lower than a complexity of the second speech recognition model.

Example 26. The method of any of examples 23 through 25, further comprising outputting, by the processing circuitry, an indication of a time at which each of the identified instances of the second key phrase occur within the audio recording.

Example 27. The method of any of examples 23 through 26, further comprising outputting, by the processing circuitry, an indication of a count of the identified instances of the second key phrase within the audio recording.

Example 28. The method of any of examples 23 through 27, wherein the first key phrase comprises a text string.

Example 29. A non-transitory, computer-readable medium comprising instructions that, when executed, are configured to cause processing circuitry of a computing system to: receive a first key phrase in a first language; convert the first key phrase into a second key phrase in a second language different from the first language, the converting comprising: determining that the computing system does not include a second word in the second language corresponding to a first word of the first key phrase; performing machine translation of the first word of the first key phrase to obtain the second word in the second language; generating a machine pronunciation of the second word in the second language; and storing, in a pronunciation dictionary, the machine pronunciation of the second word; receive an audio recording of speech in the second language; process, based at least in part on the pronunciation dictionary, the audio recording to generate a graph of words in the second language; query the graph to identify instances of the second key phrase within the audio recording; and output the identified instances of the second key phrase within the audio recording to enhance searchability of the audio recording of speech in the second language.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

Various examples have been described. These and other examples are within the scope of the following claims.

1: A system comprising:
an input device configured to:
receive a first key phrase in a first language; and
receive an audio recording of speech in a second language different from the first language;
a language conversion unit executed by the processing circuitry, the language conversion unit configured to convert the first key phrase into a second key phrase in the second language;
a word variation unit executed by processing circuitry, the word variation unit configured to process the second key phrase to produce a second key phrase variant in the second language, wherein the second key phrase variant belongs to a same classification as a classification of the second key phrase;
a speech recognition unit configured to process the audio recording to generate a graph of words in the second language;
a query unit configured to query the graph to identify instances of the second key phrase or the second key phrase variant within the audio recording; and
an output device configured to output the identified instances of the second key phrase or the second key phrase variant within the audio recording to enhance searchability of the audio recording of speech in the second language.

2: The system of claim 1, wherein to process the second key phrase to produce the second key phrase variant, the word variation unit is configured to apply a stemming operation to the second key phrase to obtain the second key phrase variant.

3: The system of claim 1, wherein the classification of the second key phrase comprises a morphology-based grouping.

4: The system of claim 1, wherein the classification of the second key phrase comprises a semantic-based grouping.

5: The system of claim 1, wherein to convert the first key phrase into the second key phrase, the language conversion unit is configured to perform machine translation of the first key phrase to obtain the second key phrase.

6: The system of claim 1, wherein to process the audio recording to generate the graph of words in the second language, the speech recognition unit is configured to:
apply a first speech recognition model to the audio recording to generate an intermediate graph of words in the second language; and
apply a second speech recognition model to the intermediate graph to generate the graph of words in the second language.

7: The system of claim 6, wherein a complexity of the first speech recognition model is lower than a complexity of the second speech recognition model.

8: The system of claim 1, wherein the output device is further configured to output an indication of a time at which each of the identified instances of the second key phrase or the second key phrase variant occur within the audio recording.

9: The system of claim 1, wherein the output device is further configured to output an indication of a count of the identified instances of the second key phrase or the second key phrase variant within the audio recording.

10: The system of claim 1, wherein the first key phrase comprises a text string.

11: The system of claim 1,
wherein the first key phrase comprises a first plurality of words in the first language,
wherein the second key phrase comprises a second plurality of words in the second language, and
wherein the second key phrase variant comprises a third plurality of words in the second language.

12: The system of claim 1,
wherein the first key phrase comprises a first plurality of words in the first language,
wherein the second key phrase comprises a second plurality of words in the second language, and
wherein the second key phrase variant comprises a plurality of second key phrase variants, wherein each second key phrase variant of the plurality of second key phrase variants comprises a third plurality of words in the second language, the third plurality of words of each second key phrase variant different from the third plurality of words of each other second key phrase variant and the second plurality of words of the second key phrase.

13: A method comprising:
receiving, by processing circuitry of a computing system, a first key phrase in a first language;
converting, by the processing circuitry, the first key phrase into a second key phrase in a second language different from the first language;
processing, by the processing circuitry, the second key phrase to produce a second key phrase variant in the second language, wherein the second key phrase variant belongs to a same classification as a classification of the second key phrase;
receiving, by the processing circuitry, an audio recording of speech in the second language;
processing, by the processing circuitry, the audio recording to generate a graph of words in the second language;
querying, by the processing circuitry, the graph to identify instances of the second key phrase or the second key phrase variant within the audio recording; and
outputting, by the processing circuitry, the identified instances of the second key phrase or the second key phrase variant within the audio recording to enhance searchability of the audio recording of speech in the second language.

14: The method of claim 13, wherein processing the second key phrase to produce the second key phrase variant comprises applying a stemming operation to the second key phrase to obtain the second key phrase variant.

15: The method of claim 13, wherein the classification of the second key phrase comprises at least one of a morphology-based grouping or a semantic-based grouping.

16. (canceled)

17: The method of claim 13, wherein converting the first key phrase into the second key phrase comprises performing machine translation of the first key phrase to obtain the second key phrase.

18: The method of claim 13, wherein processing the audio recording to generate the graph of words in the second language comprises:
applying, by the processing circuitry, a first speech recognition model to the audio recording to generate an intermediate graph of words in the second language; and
applying, by the processing circuitry, a second speech recognition model to the intermediate graph to generate the graph of words in the second language.

19. (canceled)

20: The method of claim 13, further comprising outputting, by the processing circuitry, at least one of:
an indication of a time at which each of the identified instances of the second key phrase or the second key phrase variant occur within the audio recording; or
an indication of a count of the identified instances of the second key phrase or the second key phrase variant within the audio recording.

21. (canceled)

22: The method of claim 13,
wherein the first key phrase comprises a first plurality of words in the first language,
wherein the second key phrase comprises a second plurality of words in the second language, and
wherein the second key phrase variant comprises a plurality of second key phrase variants, wherein each second key phrase variant of the plurality of second key phrase variants comprises a third plurality of words in the second language, the third plurality of words of each second key phrase variant different from the third plurality of words of each other second key phrase variant and the second plurality of words of the second key phrase.

23: A non-transitory, computer-readable medium comprising instructions that, when executed, are configured to cause processing circuitry of a computing system to:
receive a first key phrase in a first language;
convert the first key phrase into a second key phrase in a second language different from the first language;
process the second key phrase to produce a second key phrase variant in the second language, wherein the second key phrase variant belongs to a same classification as a classification of the second key phrase;
receive an audio recording of speech in the second language;
process the audio recording to generate a graph of words in the second language;
query the graph to identify instances of the second key phrase or the second key phrase variant within the audio recording; and
output the identified instances of the second key phrase or the second key phrase variant within the audio recording to enhance searchability of the audio recording of speech in the second language.

23-29. (canceled)
